(19) United States
(12) Patent Application Publication
(10) Pub. No.: US 2005/0209986 A1
(43) Pub. Date: Sep. 22, 2005

(54) Transferring service settings from a first device to a second device

(75) Inventor: Claus Pedersen, Vallensbaek (DK)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/805,976

(22) Filed: Mar. 22, 2004

(51) Int. Cl. G06F 7/00

(52) U.S. Cl. 707/1

(57) ABSTRACT

A method of transferring service settings from a first device to a second device, wherein the first and second devices each have the same predetermined hierarchical data structure, comprising: sending a data transfer request identifying a first portion of the hierarchical data structure from the first device to the second device; copying data stored at the first portion of the hierarchical data structure of the second device from the second device to the first device; storing the copied data at the first portion of the hierarchical data structure of the first device; and using, at the first device, the data stored at the first portion of the hierarchical data structure as settings for a first service.

### FIELD OF THE INVENTION

Embodiments of the invention relate to transferring service settings from a first device to a second device.

### BACKGROUND TO THE INVENTION

It is now common for a user to own or use more than one mobile telecommunication device such as a mobile cellular telephone. It is also possible for a mobile telecommunication device to be shared amongst multiple different users.

The mobile telecommunication device provides a number of different services to its user. These services are generally subscription based. The user has an account and the user may be charged for the service.

These services may, for example, include internet access, messaging services, remote storage services, email etc.

Different users may use different services and use different service providers. Even if the same service provider is used for the same service, the user may have selected personal options for the service.

A problem therefore arises when a user wishes to use a mobile communications device that they have not previously or recently used. The device will not know the users current services, service providers, service settings etc.

One option would be to configure the new phone so that it has the relevant service settings. The service settings are generally provided by the relevant service providers, for example using OMA provisioning. The user of the new device would therefore need to remember the identity of the relevant service providers and contact each in turn to achieve the necessary service settings. This is laborious and is a disincentive to a user switching to use a different mobile communications device.

It would be desirable to improve the ease with which a user can switch between using telecommunications devices.

### BRIEF DESCRIPTION OF THE INVENTION

According to one aspect of the invention there is provided a method of transferring service settings from a first device to a second device, wherein the first and second devices each have the same predetermined hierarchical data structure, comprising: sending a data transfer request identifying a first portion of the hierarchical data structure from the first device to the second device; copying data stored at the first portion of the hierarchical data structure of the second device from the second device to the first device; storing the copied data at the first portion of the hierarchical data structure of the first device; and using, at the first device, the data stored at the first portion of the hierarchical data structure as settings for a first service.

According to another aspect of the invention there is provided a method of transferring service settings from a first device to a second device, wherein the first and second devices each have the same predetermined hierarchical data structure, comprising: sending a data transfer request identifying a first portion of the hierarchical data structure from the first device to the second device; transferring the data content stored at the identified first portion of the hierarchical data structure from the second device to the first device; storing the transferred data content at the first portion of the hierarchical data structure of the first device; sending a data transfer request identifying a second portion of the hierarchical data structure from the first device to the second device; transferring the data content stored at the identified second portion of the hierarchical data structure from the second device to the first device; storing the transferred data content at the second portion of the hierarchical data structure of the first device; and using, at the first device, the settings stored at the first portion of the hierarchical data structure as settings for a first service and the settings stored at the second portion of the hierarchical data structure as settings for a second service.

According to another aspect of the invention there is provided a method of transferring service settings from a first device to a second device, wherein the first and second devices each have the same predetermined hierarchical data structure, comprising: receiving at the second device from the first device a data transfer request identifying a first portion of the hierarchical data structure; copying data stored at the identified first portion of the hierarchical data structure of the second device from the second device to the first device; and using, at the second device, the data content stored at the first portion of the hierarchical data structure as settings for a first service.

According to another aspect of the invention there is provided a mobile cellular communications device comprising: a cellular radio transceiver; a memory for storing data according to a predetermined hierarchical data structure; a processor for reading data from the memory, wherein the data read from the first portion of the hierarchical data structure is usable for providing a telecommunications service via the cellular radio transceiver; a wireless receiver for receiving a data transfer request identifying a first portion of the hierarchical data structure, wherein the processor responds to the data transfer request to read data from the first portion of the hierarchical data structure; and a wireless transmitter for transmitting the data read from the memory in response to the data transfer request.

According to another aspect of the invention there is provided a method of transferring service settings from a first device to a second device, wherein the first and second devices each have the same predetermined hierarchical data structure, comprising

sending, from the first device to the second device, a data transfer request identifying a first portion of the hierarchical data structure; receiving, at the first device from the second device, data copied from the identified first portion of the hierarchical data structure of the second device; storing, at the first portion of the hierarchical data structure of the first device, the copied data; and using, at the first device, the data content stored at the first portion of the hierarchical data structure as settings for a first service.

According to another aspect of the invention there is provided a mobile cellular communications device comprising: a cellular radio transceiver; a memory for storing data according to a predetermined hierarchical data structure; a processor for reading data from the memory, wherein the data read from the first portion of the hierarchical data structure is usable for providing a telecommunications service via the cellular radio transceiver; a wireless transmitter for sending a data transfer request identifying a first portion of the hierarchical data structure, and a wireless receiver for receiving data in response to the data transfer request, wherein the processor writes the received data to the first portion of the hierarchical data structure within the memory.

### BRIEF DESCRIPTION OF THE DRAWINGS

For a better understanding of the present invention reference will now be made by way of example only to the accompanying drawings in which:

FIG. 1 illustrates a mobile telecommunications device;

FIG. 2 illustrates one example of a hierarchical data structure; and

FIG. 3 illustrates data transfer between a first mobile communication device and a second mobile communication device.

### DETAILED DESCRIPTION OF EMBODIMENTS OF THE INVENTION

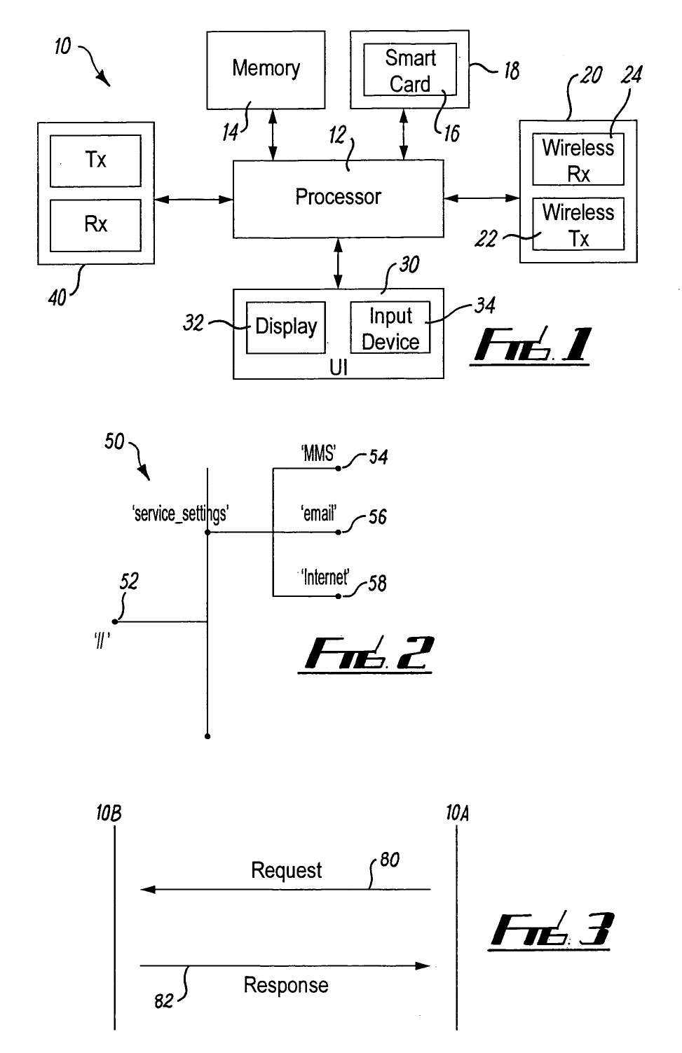

FIG. 1 illustrates a mobile telecommunications device 10. In this example the device 10 is a mobile cellular telephone.

The mobile telecommunications device 10 comprises a processor 12, a memory 14, a wireless transceiver module 20, a user interface 30 and a cellular radio transceiver 40. It may also comprise a smart card housing 18 for receiving a smart card 16.

The memory 14 stores data according to a predetermined hierarchical data structure. An example of a typical hierarchical data structure 50 is illustrated in FIG. 2. The hierarchical data structure in this example is a directory structure such as that used in MS-DOS. The data structure 50 is arranged as a tree with leaf nodes (data files) and interior nodes (folders). A leaf node depends from an interior node but does not have any nodes depending from it, whereas an interior node has one or more interior nodes or one or more leaf nodes depending from it. Data can be stored in a data file at each leaf node.

Each node has an identifier and a data file can be uniquely specified by specifying the path from the root 52 of the directory to the file using the identifiers. The identifier is typically a data file name or a folder name. Thus the file 54 can be specified by //service_settings/MMS, the file 56 can be specified by //service_settings/email and the file 58 can be specified by //service_settings/internet.

The data files contained in the folder //service_settings/ provide the service settings for telecommunications services available via the cellular radio transceiver 40. The file 54 provides the service settings for multimedia messaging (MMS). The file 56 provides the service settings for email. The file 58 provides the service settings for accessing the internet.

Each of the different service settings (i.e. the files 54, 56, 58) originate from the providers of the respective services (MMS, email, internet). Typically the service settings for a particular service are provisioned by the service provider of that service. This provisioning may occur via a smart card that is inserted into the device but generally occurs over the air using, for example, the provisioning protocol specified by the Open Mobile Alliance (OMA). These service settings are ‘owned’ by the service providers. Any changes or additions to the settings are controlled by the service provider and not by the user of the device. The data file for a particular service may also include data that identifies the selections made by a user during the initial user configuration of that service.

The user interface 30 comprises a display 32 and a user input device 34 such as a keypad, joystick or touch-screen. In this example, as the device 10 is a mobile cellular telephone the user interface also comprises audio input and audio output devices (not shown).

The wireless transceiver module 20 comprises a wireless transmitter 22 and a wireless receiver 24. The wireless transceiver may communicated by any suitable means. Bluetooth or WLAN are suitable for radio communication. Infra-Red is suitable for line of sight communication. The wireless transmitter 22 is operable as an OBEX client and the wireless receiver 24 is operable as an OBEX server. OBEX (object exchange) is a compact binary protocol that enables data exchange. It was originally developed for IrDA but can be used with other transport mechanisms.

The cellular radio transceiver 40 is capable of communicating in a cellular telecommunications network (not shown). This allows the device 10 to access remote resources and services.

The processor 12 is connected to read from and write to the memory 14, receive data from and provide data to the wireless transceiver module 20, receive commands from and supply commands to the user interface 30 and receive data from and supply data to the cellular radio transceiver 40.

The processor 12 is operable to read data files from the folder //service_setings/ of the hierarchical data structure 50 stored in memory 14 to obtain service settings that are used to access a service via the cellular radio transceiver 40. The processor 12 uses the service settings from file 54 for the MMS service, the service settings from the file 56 for the email service and the settings from the file 58 for the Internet service.

If the wireless receiver receives a data transfer request identifying a first portion of the hierarchical data structure, the device 10 responds with a data file stored in the first portion of the hierarchical data structure. The data transfer request would typically be an OBEX request packet with a GET opcode. An example of such a data transfer request is: “OBEX_GET(NAME=‘//service_settings/MMS.txt’. The processor responds to the data transfer request to read the identified data file (in this example MMS.txt). The processor 12 then sends this data file 54 to the wireless transmitter 22 which sends a response including the read data file 54. The data file 54 remains in the memory 14 and is still usable by the processor as settings for its corresponding service (MMS in this example). The wireless transmitter 22 can send a data transfer request identifying a first portion of the hierarchical data structure device 10 in order to obtain settings for a service stored in that portion of the hierarchical data structure of another device. The data transfer request would typically be an OBEX request packet with a GET opcode. An example of such a data transfer request is: “OBEX_GET(NAME=‘//service_settings/MMS.txt’. The wireless receiver 24 receives from the other device the data file in response to the data transfer request, and the processor writes the received data file to the first portion of the hierarchical data structure within the memory. In this example, the received data file would be written to //service_settings/ as MMS.txt in the hierarchical data structure. The processor 12 is subsequently able to read the received data file 54 from the memory 14 and use it for providing a telecommunications service via the cellular radio transceiver. In this example, the received data file 54 is MMS.txt and the service is MMS.

FIG. 3 illustrates data transfer between a first mobile communication device 10A and a second mobile communication device 10B. These devices are, in this example, mobile telephones used by the same person. Both devices are as described in the preceding paragraphs and each comprises a memory 14 with the same predetermined hierarchical data structure 50. Each interior node of the predetermined structure of one device has a corresponding interior node in the other device.

A direct wireless connection is formed between the wireless transceivers 20 of the first and second devices.

The wireless transmitter 22 of the first mobile communication device 10A sends, from the first device 10A to the second device 10B, a data transfer request 80 identifying a first portion of the common hierarchical data structure 50. The data transfer request would typically be an OBEX request packet with a GET opcode. An example of such a data transfer request is: “OBEX_GET(NAME=‘//service_settings/MMS.txt’, where ‘MMS.txt’ is the filename of the required data file.

The second device 10B receives the data transfer request at the wireless receiver 24. The second device 10B automatically responds to the received data transfer request by copying the requested data file stored at the first portion of the hierarchical data structure of the second device 10B from the second device to the first device. In more detail, the processor 12 responds to the data transfer request 80 by reading the identified data file (in this example MMS.txt) from the hierarchical data structure 50. The processor 12 then sends this data file to the wireless transmitter 22 which transmits a response 82 including the read data file 54 to the first device 10A. The data file 54 also remains in the memory 14 of the second device and is still usable by the processor 12 as settings when the second device 10B accesses a service (MMS in this example).

The first device 10A receives the transmitted data file 54 and stores the received data file in its memory 14 at the first portion of the hierarchical data structure 50. In this example, the received data file 54 would be written to //service_settings/ as MMS.txt in the hierarchical data structure 50. The processor 12 is subsequently able to read the received data file 54 from the memory and use it to provide service settings for the corresponding service (MMS in this example).

The first device 10A may send further data transfer requests requesting the settings for further services. It will receive in reply the data files storing the settings for these services, if present, in the second device 10B and store them for use in the first device 10A.

It will therefore be appreciated that a portion of the hierarchical data structure is copied from the second device 10B to the first device 10A. This portion may subsequently be copied from the first device 10A to a third device.

According to a second embodiment, the mobile communication device is arranged to house a smart card such as Subscriber Identity Module (SIM) card. The SIM card 16 is received in a housing 18 from which it may be removed by a user. The processor 12 and SIM card 16 are electrically interconnected. Typically the SIM card stores a unique identifier of a user such as an International Mobile Subscriber Identity (IMSI), which is used to identify a user in a mobile telecommunications network.

In this embodiment, the data files containing service settings stored in the hierarchical data structure may relate to different users. Each file is associated with an IMSI and only the data files associated with the IMSI that corresponds to the IMSI stored in the SIM card 16 presently housed in the device are accessible for use or transfer.

Each data file may contain its associated IMSI as meta-data.

The services available at a phone and the settings used therefore depends upon the data files stored in the hierarchical data structure 50 in association with the IMSI of the present SIM card. When the user of the device changes, the SIM card is changed and new data files are used. These data files determine the services available and the settings used for the new user.

When a data transfer request is received, the files that are available for transfer are restricted to those associated with the present SIM card.

Thus the SIM card is first in the second device 10B until the data files have been transferred to the first device 10A. Then when the SIM card is housed in the first device 10A the data files associated with the SIM card's IMSI are automatically used to define the first device's services and service settings.

Although embodiments of the present invention have been described in the preceding paragraphs with reference to various examples, it should be appreciated that modifications to the examples given can be made without departing from the spirit and scope of the invention. In particular, a specific form of hierarchical data structure has been described. It should be appreciated that this may take many different forms and organizational layouts.

The processes described above may be controlled by computer program instructions which are loaded into the processor 12 from the memory 14. The processor and memory in combination create a computer.

1. A method of transferring service settings from a first device to a second device, wherein the first and second devices each have the same predetermined hierarchical data structure, comprising:
sending a data transfer request identifying a first portion of the hierarchical data structure from the first device to the second device;
copying data stored at the first portion of the hierarchical data structure of the second device from the second device to the first device;
storing the copied data at the first portion of the hierarchical data structure of the first device; and
using, at the first device, the data stored at the first portion of the hierarchical data structure as settings for a first service.

2. A method as claimed in claim 1, wherein the step of copying data, comprises copying a data file stored at the first portion of the hierarchical data structure that is associated with an identifier stored in a first smart card.

3. A method as claimed in claim 2, wherein the copied data file comprises the identifier.

4. A method as claimed in claim 3, wherein the identifier is an International Mobile Subscriber Identity.

5. A method as claimed in claim 2, wherein the copied data file is usable, at the first device, as settings for a first service when the first smart card is used with the first device.

6. A method as claimed in claim 2, wherein the copied data file is automatically used, at the first device, as settings for a first service when the first smart card is used with the first device.

7. A method as claimed in claim 1, further comprising transferring a smart card from the second device to the first device before the step of using the data stored as settings for a first service.

8. A method as claimed in claim 1, wherein the copied data comprises settings originating from a provider of the first service.

9. A method as claimed in claim 1, wherein the copied data comprises settings controlled by a provider of the first service.

10. A method as claimed in claim 1, wherein the copied data includes data identifying user selections made during user configuration of the first service.

11. A method as claimed in claim 1, wherein the user of the first device is unable to amend the copied data.

12. A method as claimed in claim 1, wherein the first device is an OBEX client, the second device is an OBEX server, and the data transfer request comprises a GET request packet.

13. A method as claimed in claim 1, wherein the first and second devices are mobile telephones for use by the same person.

14. A method as claimed in claim 13, wherein the first service is a telecommunications service.

15. A method as claimed in claim 14 wherein the first service is one of:
messaging, internet access or email.

16. A method as claimed in claim 1, further comprising forming a direct connection between first and second devices and using the direct connection for sending the data transfer request and copying data from the second device to the first device.

17. A method as claimed in claim 16, wherein the direct connection is a wireless connection.

18. A method as claimed in claim 1, further comprising using, at the second device, the settings stored at the first portion of the hierarchical data structure as settings for the first service.

19. A method as claimed in claim 5, further comprising using, at the second device, the settings stored at the first portion of the hierarchical data structure as settings for the first service when the first smart card is used with the second device.

20. A method of transferring service settings from a first device to a second device, wherein the first and second devices each have the same predetermined hierarchical data structure, comprising at first portion for storing settings for accessing a first service and a second portion for storing settings for accessing a second service
sending a data transfer request identifying a first portion of the hierarchical data structure from the first device to the second device
transferring the data content stored at the identified first portion of the hierarchical data structure from the second device to the first device
storing the transferred data content at the first portion of the hierarchical data structure of the first device
sending a data transfer request identifying a second portion of the hierarchical data structure from the first device to the second device
transferring the data content stored at the identified second portion of the hierarchical data structure from the second device to the first device
storing the transferred data content at the second portion of the hierarchical data structure of the first device
using, at the first device, the settings stored at the first portion of the hierarchical data structure as settings for a first service and the settings stored at the second portion of the hierarchical data structure as settings for a second service.

21. A method of transferring service settings from a first device to a second device, wherein the first and second devices each have the same predetermined hierarchical data structure, comprising:
receiving at the second device from the first device a data transfer request identifying a first portion of the hierarchical data structure
copying data stored at the identified first portion of the hierarchical data structure of the second device from the second device to the first device
using, at the second device, the data content stored at the first portion of the hierarchical data structure as settings for a first service.

22. A method as claimed in claim 21, wherein the step of copying data, comprises copying a data file stored at the first portion of the hierarchical data structure that is associated with an identifier stored in a first smart card.

23. A method as claimed in claim 22, wherein the copied data file comprises the identifier.

24. A method as claimed in claim 23, wherein the identifier is an International Mobile Subscriber Identity.

25. A method as claimed in claim 22, wherein the copied data file is usable, at the second device, as settings for a first service only when the first smart card is used with the second device.

26. A mobile cellular communications device comprising:
a cellular radio transceiver;
a memory for storing data according to a predetermined hierarchical data structure;
a processor for reading data from the memory, wherein the data read from the first portion of the hierarchical data structure is usable for providing a telecommunications service via the cellular radio transceiver;
a wireless receiver for receiving a data transfer request identifying a first portion of the hierarchical data structure, wherein the processor responds to the data transfer request to read data from the first portion of the hierarchical data structure; and
a wireless transmitter for transmitting the data read from the memory in response to the data transfer request.

27. A mobile device as claimed in claim 26 further comprising means for housing a smart card that enables the device to participate in a telecommunications network, wherein the processor is operable to read data from the first portion of the hierarchical data structure that depends upon the identity of the housed smart card.

28. A method of transferring service settings from a first device to a second device, wherein the first and second devices each have the same predetermined hierarchical data structure, comprising:
sending, from the first device to the second device, a data transfer request identifying a first portion of the hierarchical data structure;
receiving, at the first device from the second device, data copied from the identified first portion of the hierarchical data structure of the second device;
storing, at the first portion of the hierarchical data structure of the first device, the copied data; and
using, at the first device, the data content stored at the first portion of the hierarchical data structure as settings for a first service.

29. A method as claimed in claim 28, wherein the copied data file is usable, at the first device, as settings for the first service only when a first smart card storing an identifier associated with the copied data file is used with the first device.

30. A method as claimed in claim 29, wherein the copied data file comprises an identifier.

31. A method as claimed in claim 30, wherein the identifier is an International Mobile Subscriber Identity.

32. A method as claimed in claim 29, wherein the copied data file is automatically used, at the first device, as settings for a first service when the first smart card is used with the first device.

33. A method as claimed in claim 28, further comprising transferring a smart card to the first device before the step of using the data stored as settings for a first service.

34. A mobile cellular communications device comprising:
a cellular radio transceiver;
a memory for storing data according to a predetermined hierarchical data structure;
a processor for reading data from the memory, wherein the data read from the first portion of the hierarchical data structure is usable for providing a telecommunications service via the cellular radio transceiver;
a wireless transmitter for sending a data transfer request identifying a first portion of the hierarchical data structure, and
a wireless receiver for receiving data in response to the data transfer request, wherein the processor writes the received data to the first portion of the hierarchical data structure within the memory.

35. A mobile device as claimed in claim 34, further comprising means for housing a smart card that enables the device to participate in a telecommunications network, wherein the processor is operable to read data from the first portion of the hierarchical data structure that depends upon the identity of the housed smart card.

36. A record medium embodying a computer program comprising computer program instructions for causing a computer to perform the method of claim 21.

37. A record medium embodying a computer program comprising computer program instructions for causing a computer to perform the method of claim 28.
